(19) United States
(12) Patent Application Publication
(10) Pub. No.: US 2007/0118544 A1
(43) Pub. Date: May 24, 2007

(54) Customized standard format media files

(76) Inventors: David Lundquist, Stony Brook, NY (US); Charles Ubriaco, Northport, NY (US)

Correspondence Address: FAY KAPLUN & MARCIN, LLP, 15O BROADWAY, SUITE 702, NEW YORK, NY, 10038, US

(21) Appl. No.: 11/266,953

(22) Filed: Nov. 4, 2005

(51) Int. Cl. G06F 7/00

(52) U.S. Cl. 707/101

(57) ABSTRACT

Described is a computing device comprising a first decoding module and a second decoding module. The first decoding module decodes information from a standard format media file. The second decoding module decodes additional data embedded in the standard format media file. The additional data is compatible with the standard format media file. The additional data directs operation of the computing device for the information decoded using the first decoding module.

### BACKGROUND INFORMATION

Mobile computing devices such as personal digital assistants (“PDAs”), handheld computers, etc., have architectures designed around industry standard operating systems and support the record and playback of common media file formats such as the .WAV standard. However, in many instances, the functionality provided by the mobile computing devices require additional control of media subsystems beyond what is available in standard operating systems, device drivers and media file standards. Thus, there is a need to provide additional control for the mobile computing device, while maintaining the use of standard media files.

### SUMMARY OF THE INVENTION

The present invention relates to a computing device comprising a first decoding module and a second decoding module. The first decoding module decodes information from a standard format media file. The second decoding module decodes additional data embedded in the standard format media file. The additional data is compatible with the standard format media file. The additional data directs operation of the computing device for the information decoded using the first decoding module.

### BRIEF DESCRIPTION OF THE DRAWINGS

FIG. 1 shows an exemplary mobile computing device on which the present invention may be implemented.

FIG. 2 shows an example of a canonical .WAV file format.

FIG. 3 shows an exemplary method 100 according to the present invention.

### DETAILED DESCRIPTION

The present invention may be further understood with reference to the following description and the appended drawings. The exemplary embodiments of the present invention provide a manner of encoding additional information in standard media files that allow for additional control in a computing device when the media file is executed. The exemplary embodiments will be described with reference to a standard .WAV file. However, those of skill in the art will understand that the principles and functionality described herein may be implemented with any type of standard media file to extend the functionality of standard media files.

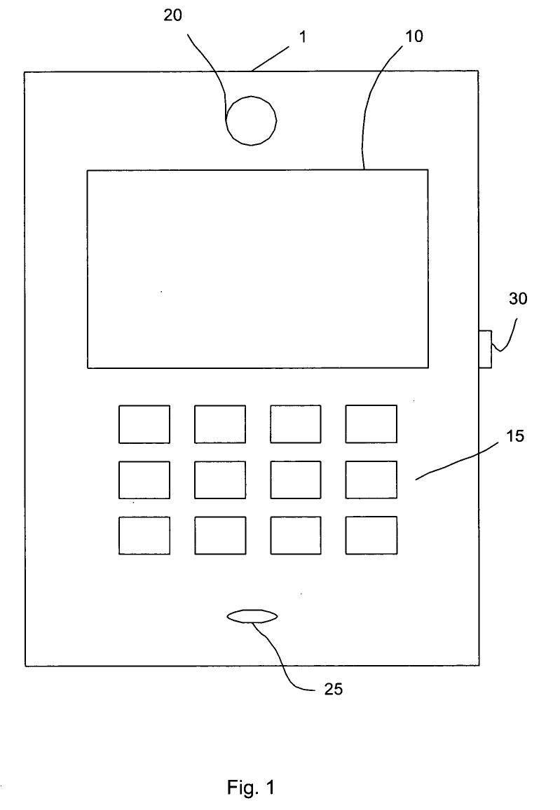

FIG. 1 shows an exemplary computing device (e.g., a mobile computing device 1) on which the present invention may be implemented. The mobile computing device 1 includes a display screen 10, a keypad 15, a speaker 20, a microphone 25 and a headset jack 30. It may also be considered that the mobile computing device 1 has a plurality of applications loaded into the device which provide the user with a set of desired functionality. Exemplary applications may include, for example, an electronic mail (“email”) application for sending and receiving emails, a Voice over Internet Protocol (“VoIP”) application for handling voice communications, a word processing application, an inventory control application, etc.

Those of skill in the art will understand that the mobile computing device 1 will also include various other hardware and software components that are not shown, e.g., a processor, memory, a wireless transceiver, an antenna, an operating system, device drivers, etc. Those of skill in the art will also understand that the mobile computing device 1 (and the described hardware/software components) is only provided as an example and that the present invention may be implemented on any type of computing device regardless of mobility. That is, the present invention may be utilized by, for example, a PC, a laptop, a PDA, a tablet, a cell phone, etc.

As part of the mobile computing device 1 operation, certain standard media files may be played by the device 1. For example, the device may include one or more .WAV files that are ring tones for the VoIP application and additional .WAV files that are system sounds for other applications, e.g., a tone that is provided when an email is received, etc. However, even though the ring tones and the other sounds are included in standard .WAV files, the user may desire the audio playback hardware to operate differently depending on the .WAV file that is being played. For example, the user may desire that the ring tones are always played to the external speaker 20, while the email tone should be played to a headset connected to the headset jack 30.

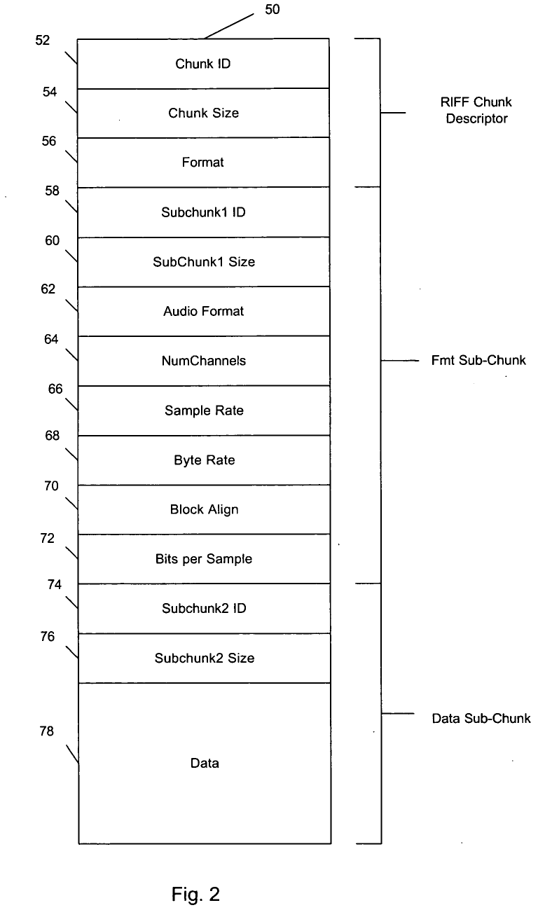

The standard .WAV files do not include the capability to provide this distinguishment to the audio playback hardware. However, it is well known that many of the common media file formats include a high degree of redundancy and/or wasted information content. For example, FIG. 2 shows an example of a canonical .WAV file format 50. The .WAV file format includes a “RIFF” chunk descriptor including the fields 52-56, the “fmt” sub-chunk including the fields 58-72 and the data sub-chunk including fields 74-78. Higher order compression schemes such as MP3 exploit these redundancies to compress the required file size.

However, in the exemplary embodiments of the present invention this redundancy is exploited to encode application specific data in a manner that is transparent to the user and does not introduce any formatting incompatibilities with the established standard. The additional information may be encoded in the least significant bit (“LSB”) of the sample stream. This additional data may then be processed by the mobile computing device 1 to provide control at the hardware level, e.g., directing playback to the correct output, level adjustments, etc.

Encoding the additional information in the file may have some effect on the actual playback of the file, but this effect may be minimal or can be minimized as described below. For example, the LSB of a 16 bit resolution .WAV file represents the signal at 1/(2¹⁵) of full scale, or just over 90 dB below the maximum amplitude. Thus, for 16 bit files it is sufficient to encode the data in the LSB because the 90 dB attenuation is adequate to make the data in the LSB inaudible. The same would apply for higher bit resolution files.

For 8 bit resolution files, the LSB represents the signal at 1/128 of full scale, resulting in an audible signal approximately 40.2 dB below full scale. Thus, further processing of the 8 bit files may be appropriate to ensure that the low level audio effect is aperiodic and noise like. This may be accomplished by multiplying of the digital information stream by a quasi-random pattern. In another exemplary embodiment, the effect is minimized by embed the data in only a fraction of the samples of the incoming stream, e.g., only encoding the additional data in the LSB of every sixth sample. Those of skill in the art will understand that there may be other manners used to attenuate the audible effect of this embedded data.

The type of data that is embedded into the LSB of the standard media file may be any type of data and may be customized for particular applications. It should be noted that this customization does not mean that the standard format is changed, but rather that the additional embedded data may be customized to perform any desired function. To continue with the example started above, the ring tones may include embedded data which directs or configures the audio playback hardware to output the audio signal through the external speaker 20. In addition, the other sound files may include embedded data that directs the audio playback hardware to output the audio signals through the headset jack 30.

It should be noted that it may be possible to re-route outputs, etc, through application program interfaces (“APIs”) at the application level. However, this requires user interaction and also may lead to conflicts where the same API is used by different applications and these different applications request different settings because there is no way to distinguish the files, i.e., they are all standard media files. Even in the situation where only a single application is using an API, the use may desire different files to operate differently, e.g., different ring tones to ring at different audible levels. This is not possible because here is no way for the API to distinguish between different standard media files.

The exemplary embodiments of the present invention allow this information to be embedded into the standard media file. Thus, there is no interaction with an API. In particular, when the media file is processed, the media file itself includes the data which directs the mobile computing device 1 to operate in the desired manner.

As described above, the embedded data may include customized data that allows the manufacturer of the mobile computing device to include proprietary data in a standard media file. Thus, only that manufacturer's devices may be able to decode the embedded data. The embedded data may also be standard type data that is used to operate standard output devices that are generic to many manufacturers.

In addition, the embedded data may not be limited to only the output device for which the media file is normally related. For example, in the ring tone example, data may be embedded in one or more of the .WAV files which not only instructs the speaker on which the ring tone is played, but it may also include embedded data that instructs other devices such as the display screen 10, e.g., when the ring tone is played, the embedded data instructs the display screen 10 to blink to provide the user with an additional cue that a voice call is being received.

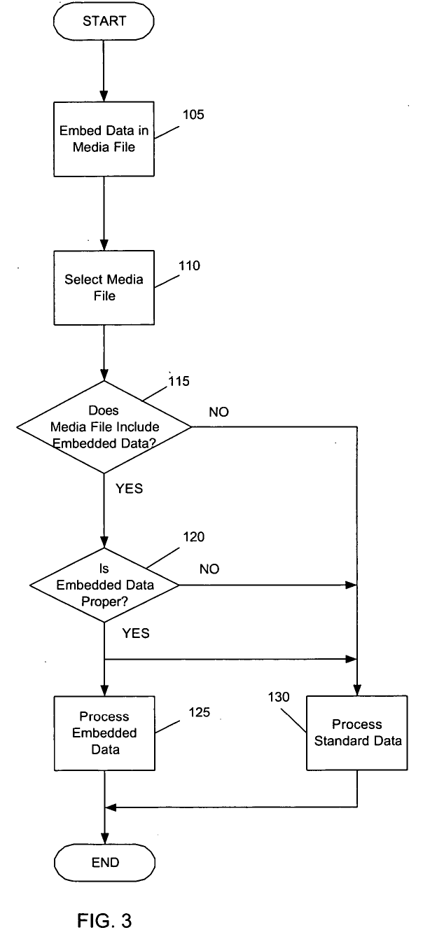

FIG. 3 shows an exemplary method 100 according to the present invention. In step 105, the desired data is embedded in the standard media file, e.g., in the LSB of a standard .WAV file. As has been described previously, the data may be any type of data and is preferable data which is used to control hardware operation of the mobile computing device.

In addition, the embedded data may be encoded in the media file in a particular location so that the ultimate decoding device (e.g., decoding software included in the mobile computing device 1) may look for the embedded data in the proper location. For example, the embedded data may start at the beginning of the sample stream so that the decoding device is aware of the data when it starts receiving the sample stream. In an alternative embodiment, the embedded data may start at a predetermined index value within the stream. In either of the above described embodiments, the decoding device may easily locate and determine if a particular stream has additional data embedded in the stream.

Moreover, the embedded data may begin with a unique header including data which indicates various information about the data that is embedded in the media file. For example, the header may identify characteristics of the embedded data such as the format, the length, the start/end of the data, etc. The decoding software may use this information to verify that the embedded data should be decoded, that the embedded data is in the correct format, etc.

In step 110, the mobile computing device 1 selects a media file to process. Continuing with the example started above, the mobile computing device 1 may receive an incoming VOIP call which causes the processing of a selected .WAV file with a ring tone. The processor (and associated software) will receive this .WAV file and start processing of the file.

Part of this processing will be to determine, in step 115, whether the .WAV file includes additional embedded data according to the exemplary embodiments of the present invention. The mobile computing device 1 will include additional decoding software to decode the embedded data. This additional decoding software may be included as part of the standard decoding software for the standard media file (e.g., .WAV decoder) or it may be separate stand alone software that processes the file independently of the standard decoder.

As described above, the embedded data may begin at some predetermined location within the .WAV file (e.g., the beginning of the file, a predetermined index value, etc.). Thus, the decoding software will look at the .WAV file and determine whether there is any embedded data in the designated location. If there is no embedded data at the designated location, the media file will be considered to not have any embedded data and the process will continue to step 130 where the standard media file will be processed in accordance with the standard decoding software, e.g., the audio ring tone will be decoded from the .WAV file.

If the decoding software determines that the media file includes embedded data, the process will continue to step 120 where it is determined whether the embedded data is proper. For example, as described above, the embedded data may include a header that includes characteristics of the embedded data. The decoding software may read this header data to determine whether the embedded data is in the expected format, etc. In addition, the decoding software may also perform error checking to ensure that random data in the media file does not appear as embedded data. Any type of error checking may be employed to ensure the quality of the data, for example, 16 bit CRC, checksums, etc.

Again, if the embedded data does not meet these quality tests, the process will continue to step 130 where the normal processing of the .WAV file data is processed. If the decoding software is assured that the embedded data is proper in step 120, the process continues to step 125 where the embedded data is processed. The process will also continue to step 130 where the normal processing of the .WAV file data is processed. Thus, assuming that a .WAV file includes properly embedded data, at the end of steps 125 and 130, the mobile computing device will have an audio signal (from the standard .WAV media file) and instructions as to what to do with the audio signal (from the additional embedded data in the .WAV file).

As described above, the embedded data may include any type of data for various types of applications. Thus, the decoding software will decode the embedded data and pass it to the proper hardware/software component so that the desired action for the audio portion of the application will be performed, e.g., audio output to the external speaker 20.

Those of skill in the art will understand that in the above description the steps 110 through 130 will be carried out by the mobile computing device 1, while the step 105 may be carried out at various locations by various individuals. That is, anyone may embed additional data into a standard media file for use on the mobile computing device 1. For example, the vendor of the VOIP application may provide the ring tone .WAV files with additional embedded data or the manufacturer of the mobile computing device may include an application which allows the embedding of additional data relating to hardware control for its device in the standard media files either by the user or by others.

Since this additional data may be embedded by anyone, the decoding software on the mobile computing device may include settings or checking algorithms to determine whether there is any corrupted or unwanted commands in the embedded data. The user may also be provided with an option to turn off the decoding software so that the embedded data is ignored.

Throughout this description it was assumed that the standard media file resided on the mobile computing device, e.g., the ring tones were provided with the VoIP application. While this is one exemplary embodiment, the present invention may also be applied to standard media files that are streamed to the mobile computing device from another source. For example, if the mobile computing device is wirelessly connected to a corporate network and the corporate network is streaming a standard media file to the mobile computing device, the standard media file may include embedded data that directs the mobile computing device to treat the media file in accordance with the desires of the owner of the corporate network. In this case, the decoding software on the mobile computing device would operate in the same manner, except that the data would be streamed from an outside source rather than being streamed from the memory of the mobile computing device.

It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. A computing device, comprising:
a first decoding module to decode information from a standard format media file; and
a second decoding module to decode additional data embedded in the standard format media file, wherein the additional data is compatible with the standard format media file, and wherein the additional data directs operation of the computing device for the information decoded using the first decoding module.

2. The computing device of claim 1, wherein the standard format media file is one of an audio file and a video file.

3. The computing device of claim 1, wherein the standard format media file is a .WAV format file.

4. The computing device of claim 3, wherein the .WAV format file is one of an 8 bit file and 16 bit file.

5. The computing device of claim 1, wherein the additional data is embedded in the least significant bits of the standard format media file.

6. The computing device of claim 5, wherein the additional data is embedded in periodic least significant bits of the standard format media file.

7. The computing device of claim 1, wherein the decoding of the additional data includes error checking of the additional data.

8. The computing device of claim 1, wherein a start of the additional data is embedded at a predetermined location in the standard format media file.

9. The computing device of claim 1, wherein the additional data includes header information.

10. The computing device of claim 1, wherein the computing device is one of an image-based scanner, a laser-based scanner, an RFID reader, a phone, a PDA, a tablet and a network interface card.

11. A method, comprising:
receiving a standard format media file;
determining if additional data is embedded in the standard format media file;
decoding the standard format media file; and
decoding the additional data, wherein the additional data includes information for using the decoded standard format media file.

12. The method of claim 11, wherein the standard format media file is one of an audio file and a video file.

13. The method of claim 11, wherein the standard format media file is a .WAV format file.

14. The method of claim 13, wherein the .WAV format file is one of an 8 bit file and 16 bit file.

15. The method of claim 11, wherein the additional data is embedded in the least significant bits of the standard format media file.

16. The method of claim 15, wherein the additional data is embedded in periodic least significant bits of the standard format media file.

17. The method of claim 11, wherein the decoding of the additional data includes error checking of the additional data.

18. The method of claim 11, wherein a start of the additional data is embedded at a predetermined location in the standard format media file.

19. The method of claim 11, wherein the additional data includes header information.

20. A computing device comprising a memory storing a set of instructions and a processor to execute the set of instructions, the set of instructions being operable to:
receive a standard format media file;
determine if additional data is embedded in the standard format media file;
decode the standard format media file; and
decode the additional data, wherein the additional data includes information for using the decoded standard format media file.
